(19) United States
(12) Patent Application Publication
(10) Pub. No.: US 2013/0346812 A1
(43) Pub. Date: Dec. 26, 2013

(54) WEAR LEVELING MEMORY USING ERROR RATE

(71) Applicants: Shirish D. Bahirat, Longmont, CO (US); Todd A. Marquart, Boise, ID (US)

(72) Inventors: Shirish D. Bahirat, Longmont, CO (US); Todd A. Marquart, Boise, ID (US)

(73) Assignee: MICRON TECHNOLOGY, INC., Boise, ID (US)

(21) Appl. No.: 13/531,139

(22) Filed: Jun. 22, 2012

(51) Int. Cl. G06F 11/16

(52) U.S. Cl. 714/704; 714/E11.054

(57) ABSTRACT

The present disclosure relates to wear leveling memory using error rate. A number of embodiments comprise: programming data to a selected group of a number of groups of memory cells based, at least partially, on a process cycle count corresponding to the selected group; determining an error rate corresponding to the selected group; and adjusting the process cycle count corresponding to the selected group based, at least partially, on the determined error rate corresponding to the selected group.

### TECHNICAL FIELD

The present disclosure relates generally to semiconductor memory and methods, and more particularly, to wear leveling memory using error rate.

### BACKGROUND

Memory devices are typically provided as internal, semiconductor, integrated circuits in computers or other electronic devices. There are many different types of memory including volatile and non-volatile memory. Volatile memory can require power to maintain its data and includes random-access memory (RAM), dynamic random access memory (DRAM), and synchronous dynamic random access memory (SDRAM), among others. Non-volatile memory can provide persistent data by retaining stored data when not powered and can include NAND flash memory, NOR flash memory, read only memory (ROM), Electrically Erasable Programmable ROM (EEPROM), Erasable Programmable ROM (EPROM), and resistance variable memory such as phase change random access memory (PCRAM), resistive random access memory (RRAM), and magnetoresistive random access memory (MRAM), among others.

Memory devices can be combined together to form a storage volume of a memory system such as a solid state drive (SSD). A solid state drive can include non-volatile memory (e.g., NAND flash memory and NOR flash memory), and/or can include volatile memory (e.g., DRAM and SRAM), among various other types of non-volatile and volatile memory.

An SSD can be used to replace hard disk drives as the main storage volume for a computer, as the solid state drive can have advantages over hard drives in terms of performance, size, weight, ruggedness, operating temperature range; and power consumption. For example, SSDs can have superior performance when compared to magnetic disk drives due to their lack of moving parts, which may avoid seek time, latency, and other electro-mechanical delays associated with magnetic disk drives.

Flash memory cells experience wear due to, for example, damage to a tunnel oxide layer as electrons move therethrough (e.g., via quantum mechanical tunneling) in association with program and erase operations. As such, the memory cells of an SSD can experience data retention issues over the lifetime of the device. As an example, some flash memory cells (e.g., multilevel cells (MLCs)) can be expected to sustain 10,000 program/erase (P/E) cycles per cell before an SSD reaches an endurance limitation, which can refer to the number of P/E cycles beyond which the SSD is no longer reliable.

The lifetime of an SSD can be determined, for instance, based on its weakest memory device (e.g., die). As an example, once individual groups of cells (e.g., blocks and/or physical pages) within a memory device of an SSD start to develop increased bit errors (e.g., an amount of bit errors which are not correctable via an error detection/correction component), the entire SSD may be considered to have reached its end of life.

In order to spread wear among groups of memory cells of an SSD, a process known as wear leveling can be used. Such wear leveling can prevent particular cells from experiencing excessive wear as compared to other cells, which can extend the life of an SSD. SSD controllers may implement wear leveling algorithms of varying complexity and/or sophistication in order to maintain even wear among cells of the SSD. As an example, some wear leveling algorithms may result in differences in wear among blocks of cells less than 0.5% or less.

### BRIEF DESCRIPTION OF THE DRAWINGS

FIG. 1 is a block diagram of an apparatus in the form of a computing system including at least one memory system in accordance a number of embodiments of the present disclosure.

FIG. 2 illustrates a diagram of a portion of a memory device having groups of memory cells organized as a number of physical blocks in accordance with a number of embodiments of the present disclosure.

FIG. 3 illustrates a method of operating a memory in accordance with a number of embodiments of the present disclosure.

FIG. 4 illustrates a method of operating a memory in accordance with a number of embodiments of the present disclosure.

FIG. 5 illustrates a functional flow diagram of a method of operating a memory in accordance with a number of embodiments of the present disclosure.

### DETAILED DESCRIPTION

The present disclosure relates to wear leveling memory using error rate. A number of embodiments comprise: programming data to a selected group of a number of groups of memory cells based, at least partially, on a process cycle count corresponding to the selected group; determining an error rate corresponding to the selected group; and adjusting the process cycle count corresponding to the selected group based, at least partially, on the determined error rate corresponding to the selected group.

A number of embodiments of the present disclosure can improve wear leveling as compared to previous techniques, which can extend the useful lifetime of a memory apparatus (e.g., an SSD), for instance. As described further herein, a number of embodiments can provide benefits such as reducing over provisioning, reducing power consumption, and improving data reliability and/or integrity as compared to previous wear leveling approaches, among other benefits.

In the following detailed description of the present disclosure, reference is made to the accompanying drawings that form a part hereof, and in which is shown by way of illustration how a number of embodiments of the disclosure may be practiced. These embodiments are described in sufficient detail to enable those of ordinary skill in the art to practice the embodiments of this disclosure, and it is to be understood that other embodiments may be utilized and that process, electrical, and/or structural changes may be made without departing from the scope of the present disclosure.

As used herein, “a number of something can refer to one or more such things. For example, a number of memory devices can refer to one or more memory devices. Additionally, the designators “N”, “B”, “R”, and “S” as used herein, particularly with respect to reference numerals in the drawings, indicates that a number of the particular feature so designated can be included with a number of embodiments of the present disclosure.

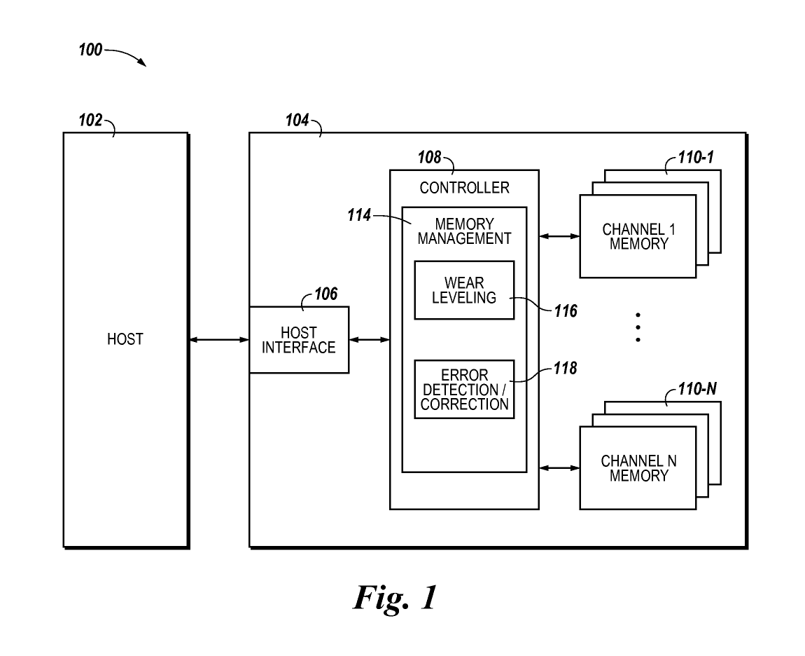

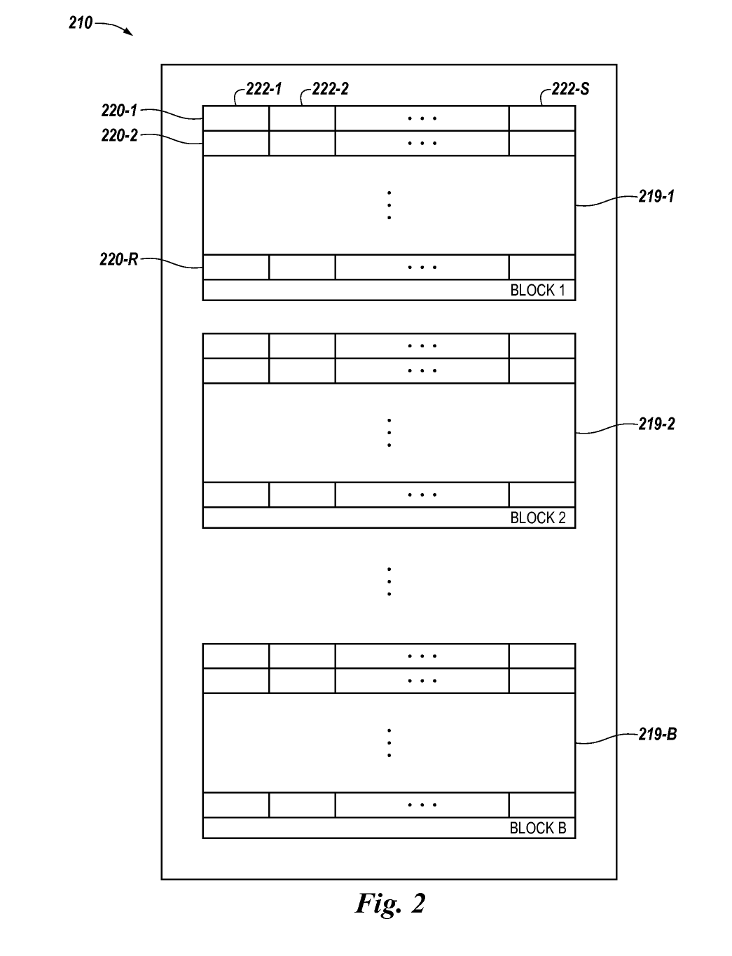

The figures herein follow a numbering convention in which the first digit or digits correspond to the drawing figure number and the remaining digits identify an element or component in the drawing. Similar elements or components between different figures may be identified by the use of similar digits. For example, 110 may reference element “10” in FIG. 1, and a similar element may be referenced as 210 in FIG. 2. As will be appreciated, elements shown in the various embodiments herein can be added, exchanged, and/or eliminated so as to provide a number of additional embodiments of the present disclosure. In addition, as will be appreciated, the proportion and the relative scale of the elements provided in the figures are intended to illustrate the embodiments of the present disclosure, and should not be taken in a limiting sense.

FIG. 1 is a block diagram of an apparatus in the form of a computing system 100 including at least one memory system 104 in accordance a number of embodiments of the present disclosure. As used herein, a memory system 104, a controller 108, or a memory device 110 might also be separately considered an “apparatus”. The memory system 104 can be a solid state drive (SSD), for instance, and can include a host interface 106, a controller 108 (e.g., a processor and/or other control circuitry), and a number of memory devices 110-1, . . . , 110-N (e.g., solid state memory devices such as NAND flash devices), which provide a storage volume for the memory system 104. In a number of embodiments, the controller 108, a memory device 110-1 to 110-N, and/or the host interface 106 can be physically located on a single die or within a single package (e.g., a managed NAND application). Also, in a number of embodiments, a memory (e.g., memory devices 110-1 to 110-N) can include a single memory device.

As illustrated in FIG. 1, the controller 108 can be coupled to the host interface 106 and to the memory devices 110-1, . . . , 110-N via a plurality of channels and can be used to transfer data between the memory system 104 and a host 102. The interface 106 can be in the form of a standardized interface. For example, when the memory system 104 is used for data storage in a computing system 100, the interface 106 can be a serial advanced technology attachment (SATA), peripheral component interconnect express (PCIe), or a universal serial bus (USB), among other connectors and interfaces. In general, however, interface 106 can provide an interface for passing control, address, data, and other signals between the memory system 104 and a host 102 having compatible receptors for the interface 106.

Host 102 can be a host system such as a personal laptop computer, a desktop computer, a digital camera, a mobile telephone, or a memory card reader, among various other types of hosts. Host 102 can include a system motherboard and/or backplane and can include a number of memory access devices (e.g., a number of processors).

The memory devices 110-1, . . . , 110-N can include a number of arrays of memory cells (e.g., non-volatile memory cells). The arrays can be flash arrays with a NAND architecture, for example. However, embodiments are not limited to a particular type of memory array or array architecture. As described further below in connection with FIG. 2, the memory cells can be grouped, for instance, into a number of blocks including a number of physical pages of memory cells. In a number of embodiments, a block refers to a group of memory cells that are erased together as a unit. A number of blocks can be included in a plane of memory cells and an array can include a number of planes. As one example, a memory device may be configured to store 8 KB (kilobytes) of user data per page, 128 pages of user data per block, 2048 blocks per plane, and 16 planes per device.

In operation, data can be written to and/or read from a memory device of a memory system (e.g., memory devices 110-1, . . . , 110-N of system 104) as a page of data, for example. As such, a page of data can be referred to as a data transfer size of the memory system. Data can be transferred to/from a host (e.g., host 102) in data segments referred to as sectors (e.g., host sectors). As such, a sector of data can be referred to as a data transfer size of the host.

The controller 108 can communicate with the memory devices 110-1, . . . , 110-N to control data read, write, and erase operations, among other operations. The controller 108 can include, for example, a number of components in the form of hardware and/or firmware (e.g., one or more integrated circuits) and/or software for controlling access to the number of memory devices 110-1, . . . , 110-N and/or for facilitating data transfer between the host 102 and memory devices 110-1, . . . , 110-N. For instance, in the example illustrated in FIG. 1, the controller 108 includes a memory management component 114, which comprises a wear leveling component 116 and an error detection/correction component 118. Embodiments are not limited to the example shown in FIG. 1. For instance, controller 108 may include other components (not shown) used in association with controlling various memory operations.

The memory management component 114 can implement wear leveling to control the wear rate on the memory devices 110-1, . . . , 110-N. Wear leveling can reduce the number of process cycles (e.g., program and/or erase cycles) performed on a particular group of cells by spreading the cycles more evenly over an entire array and/or device. Wear leveling can include dynamic wear leveling to minimize the amount of valid blocks moved to reclaim a block. Dynamic wear leveling can include a technique called garbage collection. Garbage collection can include reclaiming (e.g., erasing and making available for programming) blocks that have the most invalid pages (e.g., according to a “greedy algorithm”). Alternatively, garbage collection can include reclaiming blocks with more than a threshold amount (e.g., quantity) of invalid pages. If sufficient free blocks exist for a programming operation, then a garbage collection operation may not occur. An invalid page, for example, can be a page of data that has been updated to a different page. Static wear leveling can include writing static data to blocks that have high program/erase counts to prolong the life of the block.

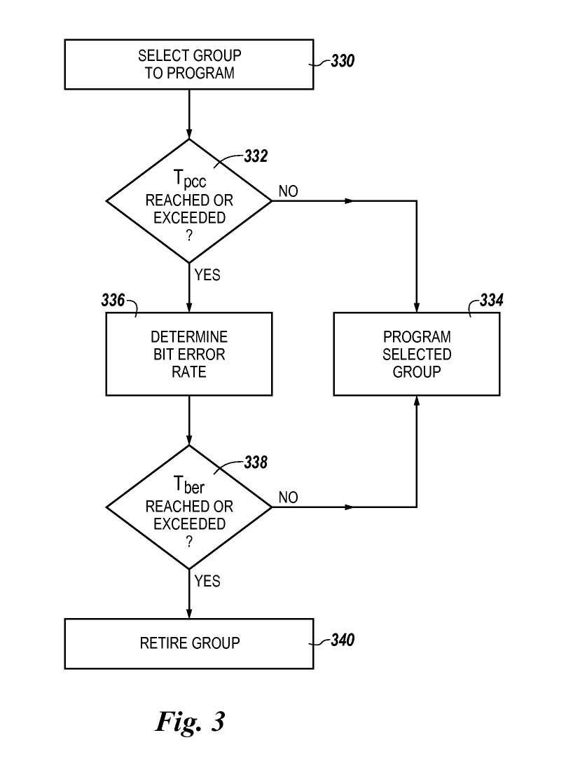

The controller 108 can be configured to control (e.g., via memory management component 114) wear leveling using error rate in accordance with a number of embodiments described herein. For instance, the error detection/correction component 118 can be used to detect and/or correct erroneous bits in association with reading data from memory devices 110-1 to 110-N. As an example, the error detection/correction component 118 can employ error correcting codes (ECC) such as low density parity check (LDPC) codes and Hamming codes, among others). In a number of embodiments, and as described further below in connection with FIGS. 3-5, the controller 108 can be configured to determine error rates corresponding to groups of memory cells (e.g., blocks and/or pages). As used herein, an error rate (e.g., a bit error rate (ber)) can refer to an amount of erroneous bits corresponding to an amount of data read from a memory (e.g., memory devices 110-1 to 110-N) divided by the total amount of data read. In a number of embodiments, the wear leveling component 116 can be used to determine the amount of process cycles (e.g., program and/or erase cycles) experienced by individual blocks and/or pages of cells, for instance. Such process cycle counts can be stored in memory (not shown) on the controller 108 and/or in the memory devices 110-1 to 110-N. In a number of embodiments, the process cycle counts and/or error rates corresponding to groups of memory cells can be tracked and used in association with wear leveling memory as described herein.

FIG. 2 illustrates a diagram of a portion of a memory device 210 having groups of memory cells organized as a number of physical blocks 219-1, 219-2, . . . , 219-B in accordance with a number of embodiments of the present disclosure. Memory device 210 can be a memory device such as memory devices 110-1 to 110-N described in FIG. 1. The memory cells of device 210 can be, for example, non-volatile floating gate flash memory cells having a NAND architecture. However, embodiments of the present disclosure are not limited to a particular type of memory device. For example, memory device 210 may include memory cells other than floating gate flash memory cells and can have an array architecture such as a NOR architecture, for instance.

As shown in FIG. 2, memory device 210 comprises a number of physical blocks 219-1 (BLOCK 1), 219-2 (BLOCK 2), . . . , 219-B (BLOCK B) of memory cells. The memory cells can be single level cells and/or multilevel cells. As an example, the number of physical blocks in an array of device 210 may be 128 blocks, 512 blocks, or 1,024 blocks, but embodiments are not limited to a particular number of physical blocks.

In the example shown in FIG. 2, each physical block 219-1, 219-2, . . . , 219-B includes memory cells which can be erased together as a unit (e.g., the cells in each physical block can be erased in a substantially simultaneous manner). For instance, the memory cells in each physical block can be erased together in a single erase operation, as will be further described herein.

As shown in FIG. 2, each physical block 219-1, 219-2, . . . , 219-B contains a number of physical rows 220-1, 220-2, . . . , 220-R of memory cells that can each be coupled to a respective access line (e.g., word line). The number of rows in each physical block can be 32, but embodiments are not limited to a particular number of rows 220-1, 220-2, . . . , 220-R per block.

As one of ordinary skill in the art will appreciate, each row 220-1, 220-2, . . . , 220-R can comprise one or more physical pages of cells. A physical page of cells can refer to a number of memory cells that are programmed and/or read together or as a functional group. In the embodiment shown in FIG. 2, each row 220-1, 220-2, . . . , 220-R can comprise one physical page of cells. However, embodiments of the present disclosure are not so limited. For instance, in one or more embodiments of the present disclosure, each row can comprise multiple physical pages of cells (e.g., one or more even pages associated with even-numbered bit lines, and one or more odd pages associated with odd numbered bit lines). Additionally, for embodiments including multilevel cells, a physical page can be logically divided into an upper page and a lower page of data, for instance, with each cell in a row contributing one or more bits towards an upper page of data and one or more bits towards a lower page of data.

In the example shown in FIG. 2, a physical page corresponding to a row can store a number of sectors 222-1, 222-2, . . . , 222-S of data (e.g., an amount of data corresponding to a host sector). The sectors 222-1, 222-2, . . . , 222-S may comprise user data as well as overhead data, such as error correction code (ECC) data and logical block address (LBA) data. It is noted that other configurations for the physical blocks 219-1, 219-2, . . . , 219-B, rows 220-1, 220-2, . . . , 220-R, and sectors 222-0, 222-1, . . . , 222-S are possible. For example, rows 220-1, 220-2, . . . , 220-R can each store data corresponding to a single sector which can include, for example, more or less than 512 bytes of data.

Memory devices such as memory device 210 can have a finite lifetime associated therewith. For instance, the cells of memory device 210 may become unreliable after a particular quantity of process cycles (e.g., program and/or erase (P/E) cycles) have been performed thereon. The particular process cycle count at which a memory device becomes unreliable can vary and can depend on various factors such as manufacturing differences between devices, operating temperatures and/or storage temperatures associated with the memory devices, and the error detection/correction capability associated with a memory device, among other factors. In various instances, a product specification may indicate a process cycle count below which the memory cells are “guaranteed” to maintain reliability. Such guaranteed process cycle counts can depend on factors such as whether the cells are single level cells or multi-level cells, for example, and can be values such as 1,000 cycles, 5,000, cycles, 10,000 cycles, or 100,000 cycles.

Some memory systems employ over-provisioning (OP) to prolong the lifetime of an SSD, for instance. OP can limit the accessible amount of memory allowed by the controller (e.g., controller 108 shown in FIG. 1) to less than the physical amount of memory present in a device. For instance, an SSD with 64 GB of physical memory can be over-provisioned to only allow 80% of its memory space to be used such that the memory space of the SSD appears (e.g., to a host) to be 51 GB. The over-provisioned 13 GB of memory can may not be accessible directly by a host, but can be treated as reserve and used by the controller in association with wear leveling, garbage collection, etc. For instance, the over-provisioned memory can be used to replace bad blocks (e.g., blocks determined to be unreliable) within the portion of the SSD accessible by the host. A block may be determined to be a bad block (e.g., via an error detection/correction component such as 118 shown in FIG. 1) based on a determined error rate corresponding thereto, for example. As another example, a block may also be determined to be a bad block once a process cycle count corresponding thereto reaches or exceeds a threshold cycle count.

In some instances, an SSD may be considered to have reached its end of life once the total bytes written (TBW) to the SSD (e.g., to the memory devices of the SSD) has reached a threshold level, which may be indicated as part of a product specification provided by the device manufacturer, for instance.

In some previous approaches, blocks of an SSD are retired when they reach or exceed a threshold program and/or erase (P/E) cycle count. To spread wear among the blocks of the SSD, wear leveling can be performed based on the program and/or erase (P/E) cycle counts. For instance, a block may be selected to receive data in association with a programming operation based on a determination that the block has a lowermost P/E cycle count corresponding thereto. However, some groups of memory cells (e.g., blocks and/or pages) are still reliable even after reaching or exceeding the threshold P/E cycle count. For example, an error rate corresponding to a block of cells may be well below a reliable threshold error rate despite the block having a reached or exceeded the threshold P/E cycle count used by the wear leveling algorithm to determine when blocks will be retired. Therefore, retiring such groups of memory cells can needlessly reduce the useful life of an SSD.

FIG. 3 illustrates a method of operating a memory in accordance with a number of embodiments of the present disclosure. A controller such as controller 108 shown in FIG. 1 can be configured to control the method illustrated in FIG. 3. At 330, the method includes selecting a group of cells to program. The group can be a block of cells (e.g., blocks 219-1 to 219-B shown in FIG. 2) or a page of cells, among other physical groupings of memory cells. The group to be programmed (e.g., to received data in association with a program operation) can be selected in association with a wear leveling process, for instance.

In a number of embodiments, the group to be programmed is selected based, at least partially, on a process cycle count corresponding to the selected group. For instance, the group having a lowermost cycle count corresponding thereto may be selected. The process cycle counts corresponding to the respective groups can be maintained in memory on the controller and/or in the groups of memory cells themselves. A number of embodiments include determining which of the respective groups of memory cells is to receive data in association with a program operation based on the maintained process cycle counts until a threshold process cycle count is reached or exceeded, and thereafter (e.g., subsequent to the threshold process cycle count being reached) determining which of the respective groups of memory cells is to receive data in association with a program operation based on determined error rates corresponding to the respective groups of memory cells.

At 332, the method includes determining whether a threshold process cycle count (Tpcc) has been reached or exceeded. The Tpcc can be a threshold amount (e.g., quantity) of program and/or erase cycles performed on the group, for instance. The Tpcc can be determined, for example, based on a product specification provided by a device manufacturer. For instance, the Tpcc may be a particular fraction of the amount of process cycles guaranteed by the product specification. As an example, if an SSD product specification indicates that the cells of the SSD are guaranteed up to 10,000 P/E cycles, then the Tpcc may be ¼ of the guaranteed amount (e.g., 2,500 cycles), ½ of the guaranteed amount (e.g., 5,000 cycles), or ¾ of the guaranteed amount (e.g., 7,500 cycles). In a number of embodiments, the method shown in FIG. 3 can include determining whether one of a number of different threshold process cycle counts have been reached or exceeded (e.g., at 332).

In the example shown in FIG. 3, if it is determined that the Tpcc of the selected group has not been reached or exceeded, then the selected group is programmed (e.g., at 334). If it is determined that the Tpcc of the selected group has been reached or exceeded, then at 336 an error rate corresponding to the selected group is determined.

At 338, the method of FIG. 3 includes determining whether a threshold error rate (Tber) corresponding to the selected group of memory cells has been reached or exceeded. In a number of embodiments, the error rate corresponding to the selected group is only determined if the Tpcc has been reached or exceeded. Responsive to a determination that the Tber of the selected group has not been reached or exceeded, the selected group is programmed (e.g., at 334). Responsive to a determination that the Tber of the selected group has been reached or exceeded, the selected group of cells can be determined to have reached the end of its useful life. As such, the selected group is retired (e.g., at 340). The Tber can be determined, for instance, by an error detection/correction component (e.g., component 118 shown in FIG. 1), and can be an error rate that is uncorrectable via the error detection/correction component. However, embodiments are not limited to a particular Tber.

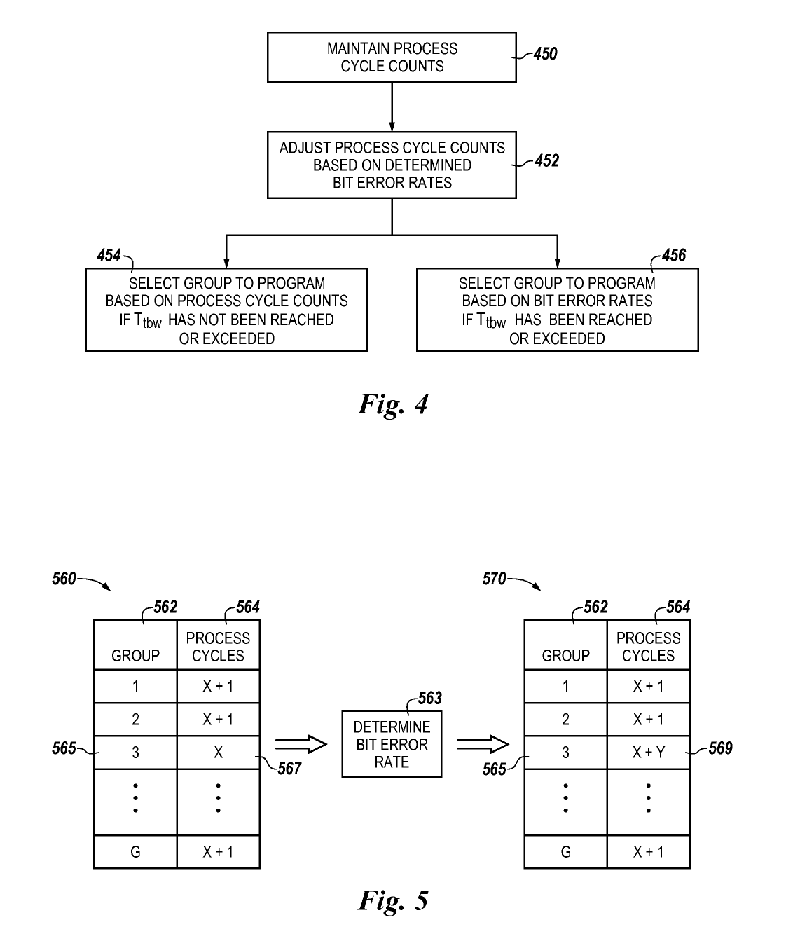

FIG. 4 illustrates a method of operating a memory in accordance with a number of embodiments of the present disclosure. A controller such as controller 108 shown in FIG. 1 can be configured to control the method illustrated in FIG. 4. At 450, the method includes maintaining process cycle counts corresponding to each of a number of respective groups of memory cells. The groups can be a blocks of cells (e.g., blocks 219-1 to 219-B shown in FIG. 2) or pages of cells, among other physical groupings of memory cells. The process cycle counts can be P/E cycle counts and can be stored in memory (e.g., DRAM) on the controller and/or in the groups of cells themselves (e.g., one block of memory cells may store the process cycle counts corresponding to each of a plurality of blocks or each block may store the process cycle count corresponding to itself).

In a number of embodiments, and as illustrated at 452, the maintained process cycle counts corresponding to the respective groups of memory cells can be adjusted based on determined error rates corresponding to the respective groups. The error rates corresponding to the groups of memory cells can be determined, for instance, responsive to the process cycle count reaching or exceeding one or more threshold counts. However, embodiments are not so limited. For example, in a number of embodiments, error rates corresponding to the respective groups of memory cells can be determined via a background sampling process. For instance, the controller can be used to determine error rates of the respective groups at various times (e.g., while data is being programmed to the memory, read from the memory, erased, and/or while an SSD is not actively processing memory commands).

In a number of embodiments, and as described further below in connection with FIG. 5, adjusting process cycle counts based on determined error rates can include adjusting the process cycle count corresponding to at least one group of memory cells from an actual amount of process cycles performed on the group to an amount of process cycles other than the actual amount of process cycles. For example, if an error rate corresponding to a particular group of memory cells is determined to be higher relative to the error rates corresponding to other groups, then the process cycle count may be increased from the actual process cycle count to a higher process cycle count. Similarly, if an error rate corresponding to a particular group of memory cells is determined to be lower relative to the error rates corresponding to other groups, then the process cycle count may be decreased from the actual process cycle count to a lower process cycle count. In this manner, a wear leveling process that selects groups to program based on process cycle counts (e.g., a wear leveling algorithm that selects groups having lowermost process cycle counts) may select a group of cells having a higher actual process cycle count as a result of the process cycle count being lowered due to a low error rate corresponding to the particular group.

In a number of embodiments, the TBW (e.g., the total amount of data programmed to an SSD) can be tracked (e.g., via a controller). As an example, wear leveling can be performed on the memory based on process cycle counts until a threshold amount of data is written to the memory, and thereafter wear leveling can be performed on the memory based on error rates. As such, groups of memory cells having high process cycle counts, which may be retired (e.g., removed from usage) due to a likelihood of unreliability and/or failure, may remain in usage for an extended period (e.g., beyond a process cycle count threshold) due to the group of cells having an acceptably low error rate.

As shown at 454, the method of FIG. 4 selects a group of memory cells to program based on process cycle counts if the threshold total bytes written (Ttbw) has not been reached or exceeded. If the Ttbw has been reached or exceeded, then the group of memory cells to be programmed is selected based on error rates, as shown at 456. Although the Ttbw may be a lifetime specification of the memory (e.g., a guaranteed TBW according to a product specification), embodiments are not so limited. For instance, the Ttbw after which a system performs wear leveling based on error rates can be various values which may or may not be related to a TBW provided by a product specification (e.g., of an SSD).

FIG. 5 illustrates a functional flow diagram of a method of operating a memory in accordance with a number of embodiments of the present disclosure. Table 560 includes a number of groups of memory cells 562 (e.g., groups 1, 2, 3, . . . , G) and process cycle counts 564 corresponding thereto. The groups 562 can be blocks of memory cells or pages of memory cells such as those described in FIG. 2, for instance. The process cycle counts 562 can be P/E cycle counts and can be maintained in memory and updated as the groups experience subsequent P/E cycles.

In a number of embodiments, a controller (e.g., controller 108 shown in FIG. 1) can be configured to control performing wear leveling on the groups 562 based on the maintained process cycle counts 564. In this example, wear leveling based on the process cycle counts includes selecting a group to be programmed that has a lowermost process cycle count. As illustrated in table 560, group 3 is the selected group 565 since the process cycle count 567 (e.g. “X”) corresponding to group 3 is less than the process cycle counts corresponding to the other groups (e.g., “X+1”).

In a number of embodiments, and as illustrated at 563, error rates corresponding to the respective groups 562 can be determined. As illustrated in table 570, the process cycle counts 564 corresponding to the respective groups 562 can be adjusted based on determined error rates corresponding to the groups. The error rates corresponding to the groups 562 can be determined responsive to the process cycle reaching or exceeding one of a number of threshold process cycle counts. For example, the error rates corresponding to the groups 562 may be determined only after the groups have experienced each of a number of particular threshold process cycle counts (e.g., after 1,000 P/E cycles, after 2,000 P/E cycles, after 5,000, and after 7,500 P/E cycles). However, embodiments are not so limited. For instance, in a number of embodiments, the error rates corresponding to the number of groups 562 may be determined via a background sampling process.

Table 570 illustrates an adjustment to the process cycle count 569 of the selected group 565 (e.g., group 3) responsive to the determined error rate corresponding thereto. In this example, the process cycle count 569 corresponding to the selected group 565 is adjusted from “X” to “X+Y”. The quantity “Y” can be a positive or negative value. That is, the maintained process cycle count 569 can be increased or decreased responsive to the determined error rate at 563. As such, in a number of embodiments, the maintained process cycle counts 564 corresponding to the groups of memory cells 562 can be adjusted (e.g., changed) from an actual value (e.g., “X”) to a different value (e.g., a value other than the actual value such as “X+Y”). Adjusting the actual values of the process cycle counts 564 can affect a wear leveling algorithm that selects groups to be programmed based on the process cycle counts corresponding to the groups. associated with the groups (e.g., by causing groups to be programmed more or less frequently due to adjustments to the process cycle counts).

In a number of embodiments, wear leveling performed on groups of memory cells (e.g., 562) can include selecting groups to be programmed based on process cycle counts (e.g., 564) until a threshold process cycle count is reached or exceeded, and thereafter selecting groups to be programmed based on determined error rates corresponding to the groups. That is, wear leveling can be based on process cycle counts until a threshold process cycle count is reached or exceeded, and then the wear leveling can be based on error rates thereafter (e.g., subsequent to a threshold process cycle count being reached or exceeded).

Using error rates in association with wear leveling as described herein can increase the useful life of a memory (e.g., an SSD), among other benefits, by better accounting for device to device (e.g., die to die) variability as compared to previous wear leveling approaches. For example, a number of embodiments of the present disclosure can reduce over provisioning and improve the reliability, data integrity, and/or performance of SSDs as compared to previous wear leveling approaches.

The present disclosure relates to wear leveling memory using error rate. A number of embodiments comprise: programming data to a selected group of a number of groups of memory cells based, at least partially, on a process cycle count corresponding to the selected group; determining an error rate corresponding to the selected group; and adjusting the process cycle count corresponding to the selected group based, at least partially, on the determined error rate corresponding to the selected group.

Although specific embodiments have been illustrated and described herein, those of ordinary skill in the art will appreciate that an arrangement calculated to achieve the same results can be substituted for the specific embodiments shown. This disclosure is intended to cover adaptations or variations of a number of embodiments of the present disclosure. It is to be understood that the above description has been made in an illustrative fashion, and not a restrictive one. Combination of the above embodiments, and other embodiments not specifically described herein will be apparent to those of skill in the art upon reviewing the above description. The scope of a number of embodiments of the present disclosure includes other applications in which the above structures and methods are used. Therefore, the scope of a number of embodiments of the present disclosure should be determined with reference to the appended claims, along with the full range of equivalents to which such claims are entitled.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A method for operating a memory, comprising:
programming data to a selected group of a number of groups of memory cells based, at least partially, on a process cycle count corresponding to the selected group;
determining an error rate corresponding to the selected group; and
adjusting the process cycle count corresponding to the selected group based, at least partially, on the determined error rate corresponding to the selected group.

2. The method of claim 1, including determining the error rate corresponding to the selected group responsive to the process cycle count corresponding to the selected group reaching or exceeding one of a number of threshold process cycle counts.

3. The method of claim 1, wherein the method includes determining the error rate corresponding to the selected group only if the process cycle count corresponding to the selected group has reached or exceeded a threshold process cycle count.

4. The method of claim 1, wherein the method includes maintaining a process cycle count for each respective group of the number of groups of memory cells.

5. The method of claim 1, including determining the error rate using an error detection/correction component coupled to the memory.

6. The method of claim 1, wherein the process cycle count is a program/erase cycle count.

7. The method of claim 1, determining an error rate corresponding to the selected group comprises performing a background sampling of error rates corresponding to the respective number of groups of memory cells.

8. A method for operating a memory, comprising:
determining a number of error rates each corresponding to a respective one of a number of groups of memory cells; and
adjusting a maintained process cycle count corresponding to at least one of the number of groups of memory cells responsive to the determined number of error rates.

9. The method of claim 8, including determining the number of error rates each corresponding to a respective one of the number of groups of memory cells responsive to a threshold process cycle count of a number of threshold process cycle counts having been reached or exceeded.

10. The method of claim 8, including adjusting the maintained process cycle count corresponding to the at least one of the number of groups of memory cells responsive only to a threshold process cycle count of a number of threshold process cycle counts having been reached or exceeded.

11. The method of claim 8, including:
maintaining process cycle counts corresponding to each of the respective groups of memory cells;
determining which of the respective groups of memory cells is to receive data in association with a program operation based on the maintained process cycle counts until a threshold process cycle count is reached or exceeded; and
determining which of the respective groups of memory cells is to receive data in association with a program operation based on determined error rates corresponding to the respective groups of memory cells subsequent to the threshold process cycle count being reached or exceeded.

12. The method of claim 8, wherein determining the number of error rates each corresponding to a respective one of a number of groups of memory cells includes determining the number of error rates only at particular threshold process cycle counts.

13. A method for operating a memory, comprising:
performing wear leveling on the memory based on a number of process cycle counts each corresponding to a respective one of a number of groups of memory cells;
determining a number of error rates each corresponding to a respective one of the number of groups of memory cells;
adjusting the number of process cycle counts corresponding to the respective groups based, at least partially, on the determined error rates corresponding to the respective groups.

14. The method of claim 13, including determining the number of error rates by using a controller configured to control determining the number of error rates via a background sampling method.

15. The method of claim 13, wherein performing wear leveling includes selecting a particular group of the number of groups of memory cells to receive data in association with a programming operation, the particular group being a group having a lowermost process cycle count corresponding thereto.

16. The method of claim 13, wherein adjusting the number of process cycle counts includes adjusting at least one of the number of process cycle counts from an actual amount of process cycles performed on a respective one of the number of groups to an amount of process cycles other than the actual amount of process cycles.

17. The method of claim 16, wherein adjusting the at least one of the number of process cycle counts from the actual amount of process cycles performed on the respective one of the number of groups to the amount of process cycles other than the actual amount of process cycles includes decreasing the at least one of the number of process cycle counts responsive to the determined error rate corresponding to the respective one of the number of groups.

18. The method of claim 16, wherein adjusting the at least one of the number of process cycle counts from the actual amount of process cycles performed on the respective one of the number of groups to the amount of process cycles other than the actual amount of process cycles includes increasing the at least one of the number of process cycle counts responsive to the determined error rate corresponding to the respective one of the number of groups.

19. An apparatus, comprising:
a memory comprising a number of groups of memory cells; and
a controller coupled to the memory and configured to control:
performing wear leveling on the memory based on a number of process cycle counts each corresponding to a respective one of the number of groups of memory cells; and
adjusting the process cycle count corresponding to a selected group of the number of groups based, at least partially, on a determined error rate corresponding to the selected group.

20. The apparatus of claim 19, wherein the number of groups of memory cells are a number of blocks of memory cells configured to be erased together in association with an erase operation.

21. The apparatus of claim 19, wherein the number of groups of memory cells are a number of pages of memory cells configured to be programmed together in association with a programming operation.

22. The apparatus of claim 19, wherein the controller is configured to control:
maintaining process cycle counts corresponding to each of the respective groups of memory cells;
determining which of the respective groups of memory cells is to receive data in association with a program operation based on the maintained process cycle counts until a threshold process cycle count is reached or exceeded; and
determining which of the respective groups of memory cells is to receive data in association with a program operation based on determined error rates corresponding to the respective groups of memory cells subsequent to the threshold process cycle count being reached or exceeded.

23. The apparatus of claim 19, wherein the controller is configured to control determining error rates corresponding to the respective number of groups via a sampling method that is performed while data is being programmed to the memory in association with a program operation and/or while data is being read from the memory in association with a read operation.

24. An apparatus, comprising:
a memory comprising a number of groups of memory cells; and
a controller coupled to the memory and configured to control:
determining that a process cycle count corresponding to a respective one of the number of groups has reached or exceeded a threshold process cycle count;
determining an error rate corresponding to the respective one of the number of groups; and
retiring the respective one of the number of groups of memory cells responsive to the determined error rate reaching or exceeding a threshold error rate.

25. The apparatus of claim 24, wherein the controller is configured to control:
tracking a total amount of data programmed to the memory; and performing wear leveling on the memory based on error rates corresponding to the respective number of groups only if the total amount of data programmed to the memory reaches or exceeds a threshold total amount of data.

26. The apparatus of claim 25, wherein the controller is configured to control:
performing wear leveling on the memory based on process cycle counts corresponding to the respective number of groups until the total amount of data programmed to the memory reaches or exceeds the threshold total amount of data.

27. The apparatus of claim 26, wherein the threshold total amount of data corresponds to a lifetime specification of the memory.

28. The apparatus of claim 24, wherein the process cycle count corresponds to an amount of program/erase (P/E) cycles performed on the respective one of the number of groups of memory cells.

29. The apparatus of claim 24, wherein the controller is configured to control determining the error rate corresponding to the respective one of the number of groups responsive to the respective one of the number of groups reaching or exceeding the threshold process cycle count.

30. A method for operating a memory, comprising:
selecting a group of memory cells to program based on process cycle counts if a threshold amount of total data programmed to the memory has not been reached or exceeded; and
if the threshold amount of total data programmed to the memory has bee reached or exceeded, selecting a group of memory cells to be programmed based on error rates.

31. A method for operating a memory, comprising:
basing wear leveling on process cycle counts until a threshold process cycle count is reached or exceeded; and
basing wear leveling on error rates after the threshold process cycle count is reached or exceeded.

32. A method for operating a memory, comprising:
determining that a process cycle count corresponding to a respective one of a number of groups of memory cells has reached or exceeded a threshold process cycle count;
determining an error rate corresponding to the respective one of the number of groups; and
retiring the respective one of the number of groups of memory cells responsive to the determined error rate reaching or exceeding a threshold error rate.
